(19) United States
(12) Patent Application Publication
(10) Pub. No.: US 2026/0172781 A1
(43) Pub. Date: Jun. 18, 2026

(54) METHODS FOR INTEGRATED COMMUNICATION AND POSITIONING IN 5G AEROMACS BASE STATIONS

(71) Applicant: BEIHANG UNIVERSITY, Beijing (CN)

(72) Inventors: Kaiquan CAI, Beijing (CN); Jingjing ZHAO, Beijing (CN); Songtao XUE, Beijing (CN); Quan ZHOU, Beijing (CN)

(73) Assignee: BEIHANG UNIVERSITY, Beijing (CN)

(21) Appl. No.: 19/411,217

(22) Filed: Dec. 6, 2025

(30) Foreign Application Priority Data
Dec. 6, 2024 (CN) 202411783660.1

(51) Int. Cl. H04W 4/02; G01S 13/08; H04W 4/029

(52) U.S. Cl. CPC H04W 4/023; G01S 13/08; H04W 4/029

(57) ABSTRACT

Provided is a method for integrated communication and positioning in a 5G AeroMACS multi-antenna base station, including: establishing a system for airport surface integrated communication and navigation, the system including the base station, single-antenna communication terminals, and mobile terminals to be located; receiving an echo signal transmitted by each mobile terminal to be located, and obtaining estimates of sensing-and-positioning parameters of the mobile terminal to be located based on the echo signal; obtaining a Cramer-Rao Bound (CRB) for the sensing-and-positioning parameters based on the estimates of the sensing-and-positioning parameters; performing minimization optimization on the CRB based on channel characteristics of communication between the base station and the single-antenna communication terminals, to obtain optimal beamforming parameters; controlling the base station to perform signal transmission, to complete communication with the plurality of single-antenna communication terminals and positioning of the plurality of mobile terminals to be located.

### CROSS-REFERENCE TO RELATED APPLICATIONS

This application claims priority to the Chinese Patent Application No. 202411783660.1, filed on Dec. 6, 2024, the contents of which are hereby incorporated by reference.

### TECHNICAL FIELD

The present disclosure relates to the field of airport wireless communication technologies, and specifically to a method for integrated communication and positioning in a 5G AeroMACS base station.

### BACKGROUND

5G AeroMACS refers to a broadband mobile communication system for airport surface operations in aviation 5G. In recent years, 5G array communication technologies represented by beamforming have achieved significant improvements in received signal strength, enhancing the quality of communication services. Meanwhile, in airport surface systems, due to the rapid movement of communication terminals and the complex and ever-changing environment, the system needs to accurately perceive the position and motion state of targets in real-time while ensuring communication quality. Thus, precise navigation services are fundamental to the efficient operation of the airport surface.

Integrated communication and navigation technology is cutting-edge in modern wireless communication systems. In airport surface systems, achieving both communication and navigation functions simultaneously can significantly enhance the overall performance and resource utilization of the system. However, the challenge of the integrated communication and navigation technology lies in realizing high-precision real-time navigation and efficient communication in high-dynamic environments. Key issues in related technological research mainly manifest in two aspects: on one hand, given the varying demands of different terminal users within an airport for communication and guidance, a 5G AeroMACS base station under limited power and functionality must balance channel capacity for communication terminals and the precision of estimating unknown target parameters. On the other hand, the rapid movement of airport terminal users and the complexity of environmental changes require the system to possess extremely high real-time processing capabilities to ensure the synchronization of navigation and communication, posing significant requirements on the computational complexity and processing efficiency of algorithms.

Therefore, one or more embodiments described in the present disclosure provide a method for integrated communication and positioning in a 5G AeroMACS base station, solving the technical problem of efficiently monitoring and tracking the position and motion state of high-dynamic mobile terminals on an airport surface that has been challenging in existing technology.

### SUMMARY

One or more embodiments of the present disclosure provide a method for integrated communication and positioning in a 5G AeroMACS base station, including the following steps:

Step S1: establishing a system for airport surface integrated communication and navigation. The system includes a 5G AeroMACS multi-antenna base station, a plurality of single-antenna communication terminals, and a plurality of mobile terminals to be located. The 5G AeroMACS multi-antenna base station performs real-time communication with the plurality of single-antenna communication terminals and the plurality of mobile terminals to be located, respectively.

Step S2: receiving, by the 5G AeroMACS multi-antenna base station, an echo signal transmitted by each of the plurality of mobile terminals to be located, and obtaining estimates of sensing-and-positioning parameters of each of the plurality of mobile terminals to be located based on the echo signal. The sensing-and-positioning parameters include a complex channel gain coefficient and an angle.

Step S3: constructing a Fisher information matrix based on the estimates of the sensing-and-positioning parameters, and obtaining a Cramer-Rao Bound (CRB) for the sensing-and-positioning parameters from the Fisher information matrix.

Step S4: performing minimization optimization on the CRB based on channel characteristics of communication between the 5G AeroMACS multi-antenna base station and the plurality of single-antenna communication terminals, to obtain optimal beamforming parameters.

Step S4-1: determining constraint conditions for performing the minimization optimization on the CRB, specifically including: determining an expression of the constraint conditions for performing the minimization optimization on the CRB:

$$\begin{matrix}{min}_{w , {R}_{x}} CRB ( {R}_{x}^{- 1} ) \\ s . t . {R}_{x} - w {w}^{H} 0 \\ tr ( {R}_{x} ) \leq {P}_{max} \\ \begin{matrix}2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \geq Γ , & ∀ k ∈\end{matrix}\end{matrix}$$

wherein Rₓ denotes a transmit covariance matrix, Re{⋅} denotes a real part operator, CRB(⋅) denotes calculating the CRB,

$${min}_{w , {R}_{x}} ( \cdot )$$

denotes optimization to a minimum value under a condition that w and Rₓ take any values,

$${R}_{x}^{- 1}$$

denotes an inverse matrix of Rₓ, s.t. denotes the constraint conditions, w denotes a precoding vector of the 5G AeroMACS multi-antenna base station, w^{H} denotes a conjugate transpose of w, Pₘₐₓ denotes a maximum transmit power, hₖ denotes a channel gain of a k-th single-antenna communication terminal,

$${h}_{k}^{H}$$

denotes a conjugate transpose of hₖ, k denotes an index of the single-antenna communication terminal, k∈ [symbol] , [symbol] ={1, 2, . . . K}, K denotes a count of the plurality of single-antenna communication terminals, w^{(q′)} denotes a precoding vector of a q′-th iteration, w^{(q′)H} denotes a conjugate transpose of

$${w}^{( q ′ )} , \qquad Γ = {σ}_{c}^{2} ( {2}^{{R}_{min}} - 1 ) , \qquad {σ}_{c}^{2}$$

denotes a noise variance at the single-antenna communication terminal, Rₘᵢₙ denotes a minimum communication rate of the single-antenna communication terminal, ∀ denotes for any.

Step S5: controlling, by using the optimal be parameters, the 5G AeroMACS multi-antenna base station to perform signal transmission, to complete communication with the plurality of single-antenna communication terminals and positioning of the plurality of mobile terminals to be located.

### BRIEF DESCRIPTION OF THE DRAWINGS

The drawings are for purposes of illustrating specific embodiments only and are not to be construed as limiting one or more embodiments of the present disclosure.

FIG. 1 is an exemplary flowchart illustrating a method for integrated communication and positioning in a 5G AeroMACS base station according to some embodiments of the present disclosure.

FIG. 2 is a schematic diagram illustrating an exemplary application scenario of a system for integrated communication and navigation on an airport surface using a 5G AeroMACS base station according to some embodiments of the present disclosure.

FIG. 3 is a flowchart illustrating a beamforming design algorithm based on successive convex approximation (SCA) according to some embodiments of the present disclosure.

FIG. 4 is a flowchart illustrating a Capon-based Maximum Likelihood (CAML) estimation algorithm according to some embodiments of the present disclosure.

Reference numerals: taxiing aircraft—10, mobile vehicle—20, ground base station—30, restricted area—40.

### DETAILED DESCRIPTION

In order to more clearly understand the above objectives, features, and advantages of one or more embodiments of the present disclosure, the one or more embodiments of the present disclosure are described in further detail below in conjunction with the accompanying drawings and specific implementations. It should be noted that, in the case of no conflict, the embodiments and features in the embodiments of one or more embodiments of the present disclosure may be combined with each other. In addition, one or more embodiments of the present disclosure may also be implemented in other ways different from those described herein. Therefore, the protection scope of one or more embodiments of the present disclosure is not limited by the specific embodiments disclosed below.

One or more embodiments described in the present disclosure provide a method for integrated communication and positioning in a 5G AeroMACS base station utilizing beamforming optimization under limited power and functionality conditions, integrating communication and sensing functions. The method balances the fundamental performance between a lower bound of multi-target parameter estimation error, i.e., the Cramer-Rao Bound (CRB), and a multicast channel capacity. Specifically, a communication and navigation integrated model for airport surface operations is first constructed, which organically combines communication and navigation functions to improve the overall system performance and efficiency by sharing spectrum resources. Based on the communication and navigation integrated model, the statistical features of echo signals are established, and then a Fisher information matrix is configured to quantify the amount of information regarding target position parameters contained in the echo data, thereby obtaining an expression of the CRB that serves as a lower bound for the variance in multi-target parameter estimation. By minimizing the CRB of multi-target parameters and using a Successive Convex Approximation (SCA) technique, a beamforming solution is obtained. This approach achieves the optimization objective while ensuring minimum multicast communication rate requirements and adhering to the maximum transmission power constraint. To estimate the sensed target position parameters, one or more embodiments of this disclosure provide a Capon Approximate Maximum Likelihood (CAML) estimation algorithm to estimate unknown parameters, such as a complex channel gain coefficient and an angle of the target. Through the integrated communication and navigation mechanism, the system can perceive the airport environment while performing communication tasks, thereby effectively monitoring and tracking the position and motion state of highly dynamic terminals on the airport surface.

In some embodiments of the present disclosure, the method for integrated communication and positioning in a 5G AeroMACS base station includes the following steps S1 to S5. The method is executed by a processor. The processor is configured in a 5G AeroMACS multi-antenna base station.

Step S1: establishing a system for airport surface integrated communication and navigation, the system includes the 5G AeroMACS multi-antenna base station, a plurality of single-antenna communication terminals, and a plurality of mobile terminals to be located. The 5G AeroMACS multi-antenna base station performs real-time communication with the plurality of single-antenna communication terminals and the plurality of mobile terminals to be located, respectively.

Step S2: receiving, by the 5G AeroMACS multi-antenna base station, an echo signal transmitted by each of the plurality of mobile terminals to be located, and obtaining estimates of sensing-and-positioning parameters of each of the plurality of mobile terminals to be located based on the echo signal, wherein the sensing-and-positioning parameters include a complex channel gain coefficient β and an angle θ.

Step S3: constructing a Fisher information matrix based on the estimates of the sensing-and-positioning parameters, and obtaining the CRB for the sensing-and-positioning parameters from the Fisher information matrix.

Step S4: performing minimization optimization on the CRB based on channel characteristics of communication between the 5G AeroMACS multi-antenna base station and the plurality of single-antenna communication terminals, to obtain optimal beamforming parameters, including the following step S4-1.

Step S4-1: determining constraint conditions for performing the minimization optimization on the CRB, including: determining an expression of the constraint conditions for performing the minimization optimization on the CRB:

$$\begin{matrix}{min}_{w , {R}_{x}} CRB ( {R}_{x}^{- 1} ) \\ s . t . {R}_{x} - w {w}^{H} 0 \\ tr ( {R}_{x} ) \leq {P}_{max} \\ \begin{matrix}2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \geq Γ , & ∀ k ∈\end{matrix}\end{matrix}$$

wherein Rₓ denotes a transmit covariance matrix, Re{⋅} denotes a real part operator, CRB(⋅) denotes calculating the CRB,

$${min}_{w , {R}_{x}} ( \cdot )$$

denotes optimization to a minimum value under a condition that w and Rₓ take any values,

$${R}_{x}^{- 1}$$

denotes an inverse matrix of Rₓ, s.t. denotes the constraint conditions, w denotes a precoding vector of the 5G AeroMACS multi-antenna base station, w^{H} denotes a conjugate transpose of w, Pₘₐₓ denotes a maximum transmit power, hₖ denotes a channel gain of a k-th single-antenna communication terminal,

$${h}_{k}^{H}$$

denotes a conjugate transpose of hₖ, k denotes an index of the single-antenna communication terminal, k∈ [symbol] , [symbol] ={1, 2, . . . K}, K denotes a count of the plurality of single-antenna communication terminals, w^{(q′)} denotes a precoding vector of a q′-th iteration, w^{(q′)H} denotes a conjugate transpose of

$${w}^{( {q}^{′} )} , Γ = {σ}_{c}^{2} ( {2}^{{R}_{min}} - 1 ) , {σ}_{c}^{2}$$

denotes a noise variance at the single-antenna communication terminal, Rₘᵢₙ denotes a minimum communication rate of the single-antenna communication terminal, V denotes for any.

Step S5: controlling, by using the optimal beamforming parameters, the 5G AeroMACS multi-antenna base station to perform signal transmission, to complete communication with the plurality of single-antenna communication terminals and positioning of the plurality of mobile terminals to be located.

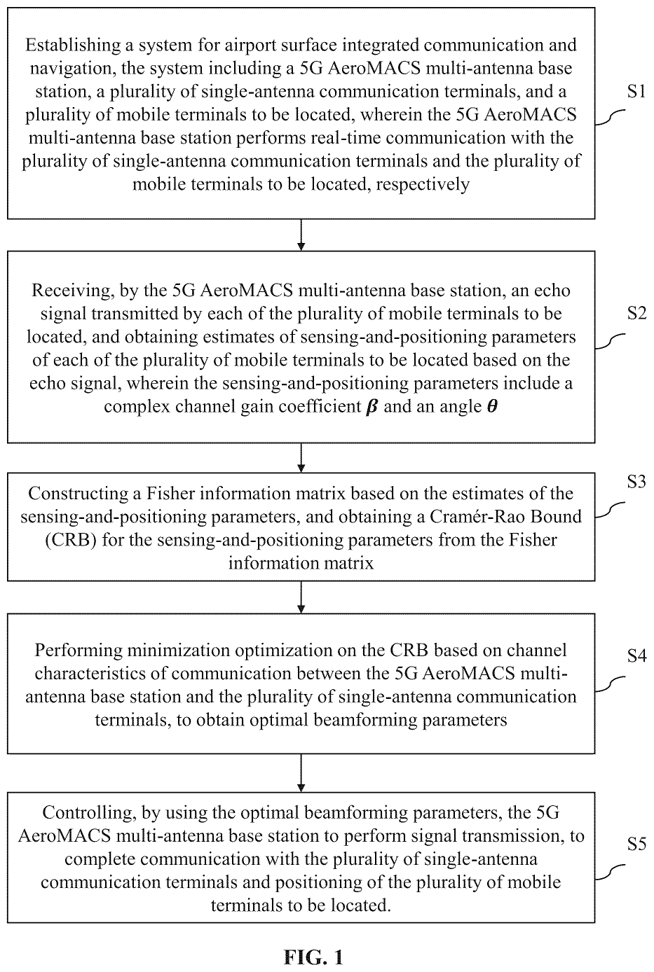

To demonstrate the effectiveness of the method provided in one or more embodiments of the present disclosure, a specific embodiment is provided below for detailed illustration of the aforementioned technical solution. As shown in FIG. 1, the method for integrated communication and positioning in a 5G AeroMACS base station is disclosed, including the following specific implementation steps:

Step S1: establishing a system for airport surface integrated communication and navigation, the system including a 5G AeroMACS multi-antenna base station, a plurality of single-antenna communication terminals, and a plurality of mobile terminals to be located. The 5G AeroMACS multi-antenna base station performs real-time communication with the plurality of single-antenna communication terminals and the plurality of mobile terminals to be located, respectively.

The system for airport surface integrated communication and navigation (also referred to as the integrated communication and positioning system, the integrated communication and navigation system, or the system) includes the 5G AeroMACS multi-antenna base station (BS) with integrated sensing and communications (ISAC) capabilities, the plurality of single-antenna communication terminals, and the plurality of mobile terminals to be located.

The 5G AeroMACS multi-antenna base station refers to a multi-antenna transmit/receive unit deployed on an airport surface for simultaneously providing air-ground and ground-ground short-range communication as well as sensing and positioning functions.

In some embodiments, the 5G AeroMACS multi-antenna base station may transmit public information signals to airport users while using the received echo signals to locate the mobile terminals to be located. By sensing the positions of various mobile terminals to be located (e.g., moving support vehicles and aircraft) on the airport surface, the 5G AeroMACS multi-antenna base station provides them with real-time directional guidance to prevent targets from approaching or entering unauthorized areas.

A single-antenna communication terminal refers to a terminal device equipped with only a single antenna for communication with the base station. For example, the single-antenna communication terminals include ground operator handheld terminals, ground vehicle static/mobile units, or the like.

A mobile terminal to be located refers to a mobile device or reflector that the base station needs to sense or locate. For example, the mobile terminals to be located may include vehicles within the apron, aviation ground equipment, carried handheld terminals, or the like.

In some embodiments of the present disclosure, the “mobile terminal to be located” is also referred to as a “target”.

In some embodiments, the 5G AeroMACS multi-antenna base station with the integrated sensing and communications capabilities is deployed on the airport surface to ensure coverage of the entire airport surface. A communication link is established between the 5G AeroMACS multi-antenna base station and the single-antenna communication terminals. Simultaneously, a sensing link is established with the mobile terminals to be located through signal transmission and reception. The 5G AeroMACS multi-antenna base station transmits the public information and the communication signals in real time to the single-antenna communication terminals and the mobile terminals to be located, thereby establishing the system for airport surface integrated communication and navigation.

The 5G AeroMACS multi-antenna base station sends public information signals to all airport users, and performs real-time communication with the single-antenna communication terminals and the mobile terminals to be located, respectively. During a communication cycle, when transmitting a signal, the 5G AeroMACS multi-antenna base station adjusts a phase and an amplitude of the signal by using a precoding vector to enhance the signal in a designated direction, thereby improving the signal coverage and reception quality.

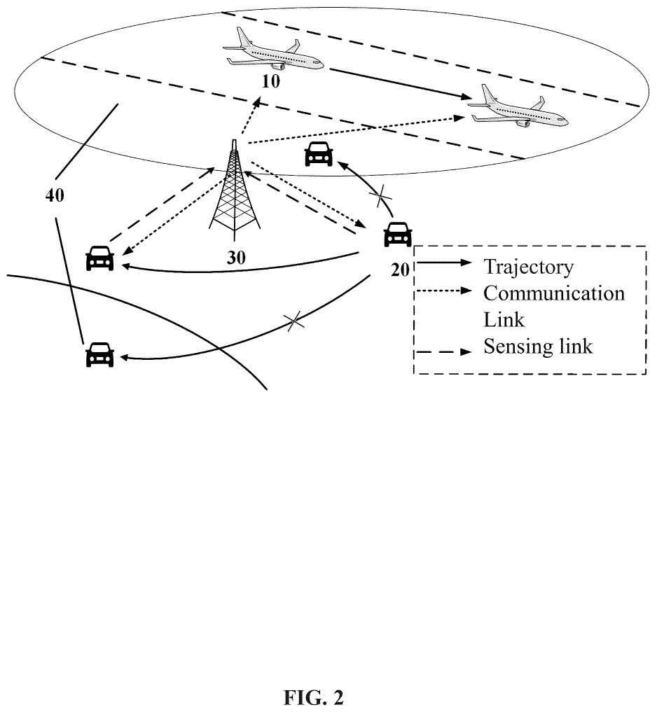

For a multi-antenna integrated communication and navigation system for airport surface management that supports information multicast and multi-target sensing, the system consists of a 5G AeroMACS multi-antenna base station (BS) with integrated sensing and communications (ISAC) capabilities, K single antenna communication terminals, and M mobile terminals to be localized. The 5G AeroMACS multi-antenna base station is equipped with two rectangular uniform linear antenna arrays, which are divided into transmit signal antennas and receive signal antennas, composed of N, antenna elements and N, antenna elements, respectively, and used to transmit and receive beamforming. The 5G AeroMACS multi-antenna base station transmits public information signals to all users at the airport and utilizes the received echo signals to simultaneously locate the M mobile terminals to be located. In this system, all user terminals may be configured as single-antenna communication terminals. As illustrated in the schematic diagram of the system for airport surface integrated communication and positioning shown in FIG. 2, the 5G AeroMACS multi-antenna base station (e.g., a ground base station 30) provides real-time directional guidance by sensing positions of mobile terminals to be located (e.g., moving support vehicles 20 and taxiing aircraft 10) on the airport surface, preventing the mobile terminals to be located from approaching or entering an unauthorized restricted area 40. At the same time, the 5G AeroMACS multi-antenna base station also engages in real-time communication with other single-antenna communication terminals, such as vehicles, on the airport surface.

For generality, the communication environment in one or more embodiments of the present disclosure is assumed to be quasi-static, meaning that the communication and sensing channels remain unchanged within one communication symbol period. A communication symbol period consists of L symbols and represents a time duration during which the system operates under quasi-static conditions. For one communication symbol period, the corresponding symbol duration is Tₛ=1/B, where B denotes a signal bandwidth. An n-th signal transmitted by the 5G AeroMACS multi-antenna base station, where n∈{1, 2, . . . L}, is expressed as:

$$x ( n ) = {ws}_{com} ( n ) + {x}_{sen} ( n ) \qquad ( 1 )$$

wherein x(n) denotes the n-th signal transmitted by the 5G AeroMACS multi-antenna base station; w denotes a precoding vector of the 5G AeroMACS multi-antenna base station, and Nₜ×1 denotes a size of the precoding vector; s_{com}(n) denotes a n-th communication signal to be transmitted with a mean of 0 and a variance of 1. xₛₑₙ(n) denotes an n-th dedicated sensing signal, which is a pseudo-random vector with a mean of zero and a covariance matrix denoted as Rₛₑₙ. The above expression represents adjusting the phase and the amplitude of the signal to be transmitted by using the precoding vector to enhance signal strength in designated directions, thereby improving signal coverage and reception quality.

The transmit covariance matrix corresponding to the transmitted signal is expressed as:

$${R}_{x} = {R}_{sen} + {ww}^{H} \qquad ( 2 )$$

wherein Rₓ denotes the transmit covariance matrix, w^{H} denotes a conjugate transpose of the precoding vector w; and Rₛₑₙ denotes a covariance matrix of the dedicated sensing signal.

The communication channels between the 5G AeroMACS multi-antenna base station and the single-antenna communication terminals are expressed by the following formula:

$${h}_{k} = {β}_{k}^{′} a ( {θ}_{k}^{′} ) \qquad ( 3 )$$

wherein hₖ denotes a channel gain of a k-th single-antenna communication terminal, k denotes the index of the single-antenna communication terminal, with k∈ [symbol] , [symbol] ={1, 2, . . . K}; β′ₖ denotes a complex channel gain from the 5G AeroMACS multi-antenna base station to the single-antenna communication terminal k; a(θ′ₖ) denotes a spatial response vector in a direction θ′ₖ of the channel; and θ′ₖ denotes the direction of the k-th single-antenna communication terminal;

At this point, an n-th signal yₖ(n) received at a receiver of the k-th single-antenna communication terminal is:

$${y}_{k} ( n ) = {h}_{k} x ( n ) + {n}_{k} ( n ) \qquad ( 4 )$$

$$wherein {n}_{k} ( n ) \sim CN ( 0 , {σ}_{c}^{2} )$$

denotes a noise signal received by the k-th single-antenna communication terminal, and the noise signal is additive white Gaussian noise with a mean of 0 and a variance of

$${σ}_{c}^{2} .$$

Based on the received signal in the formula (4), a received signal-to-noise ratio (SNR) at the k-th single-antenna communication terminal is:

$${γ}_{k} ( {R}_{x} ) = 𝔼 ( \frac{{\vert {h}_{k}^{H} , x ( n ) \vert}^{2}}{{\vert {z}_{k} ( n ) \vert}^{2}} ) = \frac{{h}_{k}^{H} {R}_{x} {h}_{k}}{{σ}_{c}^{2}} \qquad ( 5 )$$

wherein γₖ(Rₓ) denotes the received SNR of the k-th single-antenna terminal, [symbol] (⋅) denotes calculation of an expectation;

$${h}_{k}^{H}$$

denotes the conjugate transpose of hₖ; and |⋅∥ denotes calculation of a modulus of a complex number.

A communication rate between the 5G AeroMACS multi-antenna base station and the single-antenna communication terminal is expressed as:

$${R}_{k} ( {R}_{x} ) = {log}_{2} ( 1 + \frac{{h}_{k}^{H} {R}_{x} {h}_{k}}{{σ}_{c}^{2}} ) \qquad ( 6 )$$

wherein Rₖ(Rₓ) denotes the communication rate of the k-th single-antenna terminal.

Formulas (5) and (6) describe the signal-to-noise ratio and the communication rate of the system for airport surface integrated communication and navigation provided in one or more embodiments of the present disclosure.

Step S2: receiving, by the 5G AeroMACS multi-antenna base station, an echo signal transmitted by each of the plurality of mobile terminals to be located and obtaining estimates of sensing-and-positioning parameters of each of the plurality of mobile terminals to be located based on the echo signal. The sensing-and-positioning parameters include a complex channel gain coefficient β and an angle θ.

The echo signal refers to the reflection of the base station's transmitted signal from the mobile terminal to be located or a surrounding object, or a return signal actively transmitted by the mobile terminal to be located and received by the base station. For example, the echo signal may be a return sample of a continuous wave, a pulse, an orthogonal frequency division multiplexing (OFDM) pilot, or other communication/detection hybrid waveforms.

More descriptions of the echo signal may be found in the corresponding content later.

The sensing-and-positioning parameters are information related to tracking the position of the mobile terminal to be located, and the sensing-and-positioning parameters include the complex channel gain coefficient β and the angle θ. The complex channel gain coefficient β denotes the complex channel gain coefficient of the reflection channel. The angle θ denotes the direction of the mobile terminal to be located relative to the base station.

In some embodiments, based on the echo signal, the 5G AeroMACS multi-antenna base station employs a Capon Approximate Maximum Likelihood (CAML) estimation algorithm to obtain the estimates of the sensing-and-positioning parameters. By combining the high angular resolution characteristics of Capon beamforming with the statistical optimization capability of Maximum Likelihood Estimation (MLE), the algorithm aims to achieve high-precision target parameter estimation in complex multi-target sensing scenarios.

In some embodiments, step S2 includes: step S2-1: receiving, by the 5G AeroMACS multi-antenna base station from an echo channel, the echo signal transmitted by each of the plurality of mobile terminals to be located; step S2-2: determining initial values of the sensing-and-positioning parameters based on a Capon beamforming power spectrum, and determining a likelihood function based on the initial values of the sensing-and-positioning parameters; and step S2-3: performing maximization optimization on the likelihood function through gradient descent to obtain optimal sensing-and-positioning parameters, and designate the optimal sensing-and-positioning parameters as the estimates of the sensing-and-positioning parameters.

In some embodiments, in step S2-1, the echo signal is expressed as:

$$y ( n ) = {\sum }_{m = 1}^{M} G ( m ) x ( n ) + z ( n )$$

wherein y(n) denotes the n-th signal received by the 5G AeroMACS multi-antenna base station; x(n) denotes the n-th signal transmitted by the 5G AeroMACS multi-antenna base station; n denotes a symbol index, and n∈{1, 2, . . . L}; L denotes a total count of symbols in a communication symbol period; G(m) denotes an echo channel gain between the 5G AeroMACS multi-antenna base station and an m-th mobile terminal to be located; m denotes an index of the mobile terminal to be located, and m∈{1, 2, . . . M}; and M denotes a total count of the mobile terminals to be located; and z(n) denotes additive white Gaussian noise of the n-th signal.

In some embodiments of the present disclosure, the processor obtains coefficients involved in the echo signal expression by invoking system-stored data, acquiring real-time measurement data, or through any other feasible means.

Assume X=[x(1), . . . , x(L)] denotes the transmitted signal over a symbol period consisting of L symbols. Assuming L is sufficiently large, a sample covariance matrix of X may be approximated as the statistical covariance matrix Rₓ, i.e.:

$$\frac{1}{L} {XX}^{H} \approx {R}_{x} \qquad ( 7 )$$

The 5G AeroMACS multi-antenna base station performs sensing on the mobile terminals to be located. The characteristics of the sensing echo channel between the 5G AeroMACS multi-antenna base station and the mobile terminals to be located are expressed as:

$$G ( m ) = {β}_{m} {a}_{r} ( {θ}_{m} ) \times {a}_{t}^{H} ( {θ}_{m} ) \qquad ( 8 )$$

wherein G(m) denotes the echo channel gain between the 5G AeroMACS multi-antenna base station and the m-th mobile terminal to be located, m denotes an index of the mobile terminal to be located, m∈{1, 2, . . . M}; βₘ denotes the complex channel gain coefficient of the reflection channel; aₜ(θₘ) and aᵣ(θₘ) denote a transmitted steering vector and a received steering vector, respectively, at antennas of the 5G AeroMACS multi-antenna base station,

$${a}_{t}^{H} ( {θ}_{m} )$$

denotes a conjugate transpose of aₜ(θₘ), and θₘ denotes an angle of the m-th mobile terminal to e located.

A target echo signal y(n) received at the 5G AeroMACS multi-antenna base station for a symbol n∈{1, 2, . . . L} is represented as:

$$y ( n ) = {\sum }_{m = 1}^{M} G ( m ) x ( n ) + z ( n ) \qquad ( 9 )$$

$$wherein z ( n ) ∼ CN ( 0 , {σ}_{r}^{2} I )$$

denotes that z(n) is additive white Gaussian noise at a receiving antenna, with a noise power of

$${σ}_{r}^{2} .$$

To facilitate derivation of the CRB matrix for estimating target parameters, the formula (9) is re-formulated as follows:

$$Y = {A}_{r}^{*} B {A}_{t}^{H} X + Z \qquad ( 10 )$$

wherein Y=[y(1), . . . , y(L)], Z=[z(1), . . . , z(L)], the antenna steering vectors are

$${A}_{r} = [ ( {a}_{r} ( {θ}_{1} ) , {a}_{r} ( {θ}_{2} ) , … , {a}_{r} ( {θ}_{M} ) ] , {A}_{t} = [ {α}_{t} ( {θ}_{1} ) , {a}_{t} ( {θ}_{2} ) , … , {a}_{t} ( {θ}_{M} ) ] , {A}_{r}^{⋆}$$

denotes a complex conjugate matrix of Aᵣ,

$${A}_{t}^{H}$$

denotes a conjugate transpose of Aₜ, Y denotes a received signal matrix, Z denotes a noise matrix, X denotes a transmit signal matrix, B denotes a complex channel gain coefficient matrix, B=diag(β), β=[β₁, . . . , β_{M}], and diag(⋅) denotes constructing a diagonal matrix.

The echo signal model explicitly expresses the signal received by the base station as a linear superposition of a plurality of target echo components, endowing the sensing parameters with clear physical meaning and identifiable structure, and enabling direct construction of the Fisher information matrix and the CRB. The echo signal model also explicitly incorporates the transmitted signal, allowing joint design and optimization of communication and positioning performance within a unified framework, and offering favorable engineering feasibility and scalability. The above approach enhances the overall performance and reliability of the system for airport surface integrated communication and positioning.

In some embodiments, the processor determines initial angles of the mobile terminals to be located by searching for angles corresponding to peak values of the Capon beamforming power spectrum. For example, the processor may select the angles corresponding to the M largest peaks in the power spectrum as the initial angles of the M mobile terminals to be located. Based on the initial angle, the processor further calculates the initial value of the complex channel gain coefficient.

The likelihood function measures the probability of observing an actual echo signal given parameters.

The processor determines the likelihood function of an observed received signal based on the initial values of the sensing-and-positioning parameters and the received echo signal.

In some embodiments, step S2-2 includes:

For each candidate target angle, calculating a Capon power spectrum, designating an angle corresponding to a peak value of the Capon power spectrum as an initial angle θᵢₙᵢₜ, and simultaneously selecting an initial complex channel gain coefficient βᵢₙᵢₜ; and based on the θᵢₙᵢₜ and the βᵢₙᵢₜ, calculating the likelihood function according to the following formula:

$$ℒ ( β , θ ) = {\prod }_{n = 1}^{L} \frac{1}{{π}^{M} {σ}_{r}^{2}} exp ( - \frac{‖ y ( n ) - {\sum }_{m = 1}^{M} {β}_{m} {a}_{r} ( {θ}_{m} ) {a}_{t}^{H} ( {θ}_{m} ) x ( n ) {‖}^{2}}{{σ}_{r}^{2}} ) ℒ ( β , θ )$$

denotes the likelihood function of observing the received signal y(n) given β, θ, βₘ denotes a complex channel gain coefficient of the m-th mobile terminal to be located, aₜ(θₘ) and aᵣ(θₘ) denote a transmit steering vector and a receive steering vector, respectively, at the antennas of the 5G AeroMACS multi-antenna base station,

$${a}_{t}^{H} ( {θ}_{m} )$$

denotes a conjugate transpose of aₜ(θₘ), θₘ denotes an angle of the m-th mobile terminal to be located, exp(⋅) denotes an exponential function with base e, ∥⋅∥² denotes a squared L2 norm,

$${σ}_{r}^{2}$$

denotes a noise power at the receiving antenna.

The estimated complex channel gain coefficient of the target β and the target angle θ are used as unknown parameters. The M targets are tracked by estimating their complex channel gain coefficients and angles. For the estimation of multi-target parameters, one or more embodiments of the present disclosure provide a Capon Approximate Maximum Likelihood (CAML) estimation technique to estimate unknown parameters, such as the complex channel gain coefficient of the target and the angle of the target. By combining the highly angular resolution characteristic of Capon beamforming and the statistical optimization capability of MLE, precise estimation of the multi-target parameters is achieved. The specific process is as follows:

Assuming the received signal is a superposition of signals from M targets, with the signal model as shown in the formula (9), Capon beamforming is utilized to estimate direction information of the target in the signal.

For each candidate target angle, the Capon beamforming power spectrum is calculated using the following formula:

$${P}_{Capon} ( θ ) = \frac{1}{{a}_{t}^{H} ( θ ) {R}_{y}^{- 1} {a}_{t} ( θ )} \qquad ( 12 )$$

wherein P_{Capon}(θ) denotes the beamforming power spectrum of a target angle θ,

$${R}_{y}^{- 1}$$

denotes the inverse matrix of the covariance matrix Ry of the received signal.

$${R}_{y} = \frac{1}{L} {\sum }_{n = 1}^{L} y ( n ) {y}^{H} ( n ) ,$$

aₜ(θ) denotes the transmit steering vector of the target angle θ, and

$${a}_{t}^{H} ( θ )$$

denotes the conjugate transpose of aₜ(θ). After obtaining the initial estimates from the Capon power spectrum, the likelihood function of the target parameters is constructed. The goal of MLE is to maximize the likelihood function. Since noise follows a Gaussian distribution, the likelihood function is:

$$ℒ ( β , θ ) = {\prod }_{n = 1}^{L} \frac{1}{{π}^{M} {σ}_{r}^{2}} exp ( - \frac{{‖ y ( n ) - {\sum }_{m = 1}^{M} {β}_{m} {a}_{r} ( {θ}_{m} ) {a}_{t}^{H} ( {θ}_{m} ) x ( n ) ‖}^{2}}{{σ}_{r}^{2}} ) \qquad ( 13 )$$

wherein [symbol] (β, θ) denotes the likelihood function of observing the received signal y(n) given β, θ, βₘ denotes the complex channel gain coefficient of the m-th mobile terminal to be located, exp(⋅) denotes an exponential function with base e, ∥⋅∥² denotes a squared L2 norm.

In some embodiments of the present disclosure, the processor obtains coefficients involved in the likelihood function by invoking system-stored data, obtaining real-time measurement data, or through any other feasible manners.

This parameterization and estimation procedure, based on a physically interpretable array-echo model and combining Capon-based initial estimates with likelihood optimization, rapidly yields high-precision estimates of angles and complex gains, providing reliable input for subsequent CRB computation and joint communication-positioning beamforming optimization, thereby enhancing positioning accuracy and communication resource utilization efficiency.

In some embodiments, the processor performs gradient descent by using the following formulas to iteratively update the sensing-and-positioning parameters:

$${β}_{m}^{( q + 1 )} = {β}_{m}^{( q )} + {η}_{β} {∇}_{{β}_{m}}$$

$${θ}_{m}^{( q + 1 )} = {θ}_{↑ n}^{( q )} + {η}_{θ} {∇}_{{θ}_{m}}$$

$${∇}_{{β}_{m}} = {\sum }_{n = 1}^{L} 2 \cdot Re \{ {a}_{r}^{H} ( {θ}_{m}^{( q )} ) {a}_{t} ( {θ}_{m}^{( q )} ) x ( n ) {( y ( n ) - {\sum }_{p = 1}^{M} {β}_{p}^{( q )} {a}_{r} ( {θ}_{p}^{( q )} ) {a}_{t}^{H} ( {θ}_{p}^{( q )} ) x ( n ) )}^{H} \}$$

$${∇}_{{θ}_{m}} = {\sum }_{n = 1}^{L} 2 \cdot Re \{ {β}_{m}^{( q )} \frac{\partial }{\partial {θ}_{m}} ( {a}_{r} ( {θ}_{m}^{( q )} ) {a}_{t}^{H} ( {θ}_{m}^{( q )} ) x ( n ) ) {( y ( n ) - {\sum }_{p = 1}^{M} {β}_{p}^{( q )} {a}_{r} ( {θ}_{p}^{( q )} ) {a}_{t}^{H} ( {θ}_{p}^{( q )} ) x ( n ) )}^{H} \}$$

$$where in {θ}_{m}^{( q )} and {θ}_{p}^{( q )}$$

denote values of θₘ and θₚ at a q-th iteration, respectively, θₚ denotes an angle of a p-th mobile terminal to be located,

$${β}_{m}^{( q )} and {β}_{p}^{( q )}$$

denote values of βₘ and βₚ, of at the q-th iteration, respectively, βₚ denotes a complex channel gain coefficient of the p-th mobile terminal to be located

$${β}_{m}^{( q + 1 )} and {θ}_{m}^{( q + 1 )}$$

denote values of βₘ and θₘ of a (q+1)-th iteration, respectively, η_{β} and η_{θ} denote an iteration step size for β and an iteration step size for θ, respectively, Re{⋅} denotes the real part operator, and

$$\frac{\partial }{\partial {θ}_{m}}$$

denotes taking a partial derivative with respect to θₘ.

During the iteration, if a change in the sensing-and-positioning parameters is less than a preset threshold, the processor outputs the estimates of the sensing-and-positioning parameters, denoted as (\hat{β}ₘ, \hat{θ}ₘ).

Adopting the Capon initial values combined with the gradient iteration described above effectively integrates rapid spectral estimation with refined likelihood optimization, thereby accelerating convergence and improving estimation accuracy of the angles and complex gains. This approach has moderate computational complexity and is easy to implement. The resulting high-quality parameter estimates can be directly used to construct the Fisher information matrix, calculate the CRB, and guide subsequent joint beamforming optimization, thereby significantly enhancing positioning accuracy and system resource utilization efficiency.

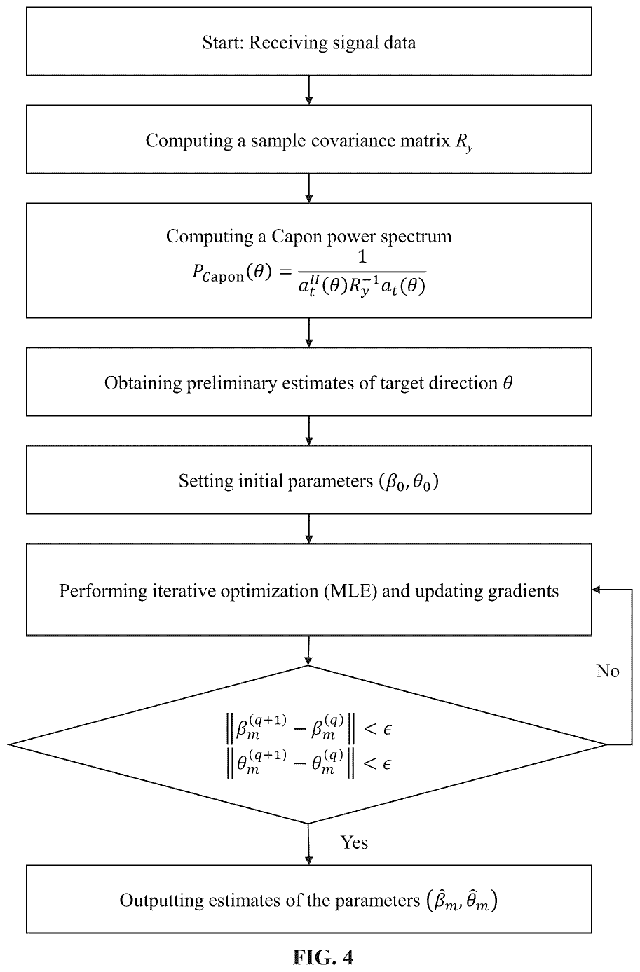

As shown in the flowchart of the Capon-based Maximum Likelihood (CAML) estimation algorithm in FIG. 4, the process of CAML estimation combining Capon beamforming and MLE for parameter optimization mainly includes the following three steps:
(1) Performing an initial estimation, use peak positions of the Capon power spectrum as initial angles θᵢₙᵢₜ, and selecting initial complex channel gain coefficients βᵢₙᵢₜ at the same time.
(2) For each initial estimated angle and each initial complex channel gain coefficient, determining a likelihood function for the complex channel gain coefficient and the angle.
(3) Performing maximization optimization on the likelihood function through gradient descent to obtain optimal sensing-and-positioning parameters (\hat{β}ₘ, \hat{θ}ₘ). In each iteration, the gradient of a current estimated sensing-and-positioning parameters is determined for updating target parameters, wherein the gradient of a complex channel gain coefficient P is:

$${∇}_{{β}_{m}} = {\sum }_{n = 1}^{L} 2 \cdot Re \{ {a}_{r}^{H} ( {θ}_{m}^{( q )} ) {a}_{t} ( {θ}_{m}^{( q )} ) x ( n ) {( y ( n ) - {\sum }_{p = 1}^{M} {β}_{p}^{( q )} {a}_{r} ( {θ}_{p}^{( q )} ) {a}_{t}^{H} ( {θ}_{p}^{( q )} ) x ( n ) )}^{H} \} \qquad ( 14 )$$

$$wherein {θ}_{m}^{( q )} and {θ}_{p}^{( q )}$$

denote the values of θₘ and θₚ at the q-th iteration, respectively; θₘ and θₚ denote the angle of the m-th mobile terminal to be located and the angle of the p-th mobile terminal to be located, respectively; p denotes a summation index; and q denotes the count of iterations.

Due to the nonlinear nature of steering vectors, the angle gradient is approximately determined, and the gradient with respect to an angle θ is calculated using the following formula:

$${∇}_{{θ}_{m}} = {\sum }_{n = 1}^{L} 2 \cdot Re \{ {β}_{m}^{( q )} \frac{\partial }{\partial {θ}_{m}} ( {a}_{r} ( {θ}_{m}^{( q )} ) {a}_{t}^{H} ( {θ}_{m}^{( q )} ) x ( n ) ) {( y ( n ) - {\sum }_{p = 1}^{M} {β}_{p}^{( q )} {a}_{r} ( {θ}_{p}^{( q )} ) {a}_{t}^{H} ( {θ}_{p}^{( q )} ) x ( n ) )}^{H} \} \qquad ( 15 )$$

$$wherein {β}_{m}^{( q )} and {β}_{p}^{( q )}$$

denote the values of βₘ and βₚ of at the q-th iteration, respectively, βₘ and βₚ denote the complex channel gain coefficient of the m-th mobile terminal to be located and the complex channel gain coefficient of the p-th mobile terminal to be located, respectively, and

$$\frac{\partial }{\partial {θ}_{m}}$$

denotes taking a partial derivative with respect to θₘ.

The estimates of the sensing-and-positioning parameters are iteratively updated using the gradient descent technique according to the following formulas:

$${β}_{m}^{( q + 1 )} = {β}_{m}^{( q )} + {η}_{β} {∇}_{{β}_{m}} \qquad ( 16 a )$$

$${θ}_{m}^{( q + 1 )} = {θ}_{m}^{( q )} + {η}_{θ} {∇}_{{θ}_{m}} \qquad ( 16 b )$$

$$wherein {β}_{m}^{( q + 1 )} and {θ}_{m}^{( q + 1 )}$$

denote the values of βₘ and θₘ at a (q+1)-th iteration, respectively; η_{β} and η_{θ} denote the iteration step size for β and the iteration step size for θ, respectively. During the iteration process, if a change in the sensing-and-positioning parameters is less than a preset threshold, the iteration converges and the estimates of the sensing-and-positioning parameters (\hat{β}ₘ, \hat{θ}ₘ) are output.

An objective of maximization optimization is to find the sensing-and-positioning parameters (the complex channel gain coefficient and the angle) corresponding to a maximum value of the likelihood function.

In some embodiments, the processor adopts the iteration approach, starting from the initial values determined in step S2-2, and progressively updates the parameters in the direction of gradient ascent (i.e., the positive direction of the derivative) of the likelihood function. The processor repeats the iterative update process until a convergence condition is satisfied (e.g., the change in the sensing-and-positioning parameters is less than a preset threshold or a maximum iteration count is reached), thereby obtaining optimal sensing-and-positioning parameters as the estimates of the sensing-and-positioning parameters.

By adopting the gradient descent technique to optimize parameters in CAML estimation, high-precision estimation of target parameters can be achieved in complex multi-target sensing scenarios. This process utilizes the initial directional sensitivity of the Capon beamforming and precisely optimizes parameters through iterative updates, thereby enhancing the sensing performance of the system. Finally, after obtaining the estimates of the target parameters, the sensing capability of the estimator is evaluated by comparing the Root Mean Square Error (RMSE) of the estimates with the CRB.

In some embodiments, in step S2-3, determining the iteration step size Ye includes: determining a base step size; determining a scene dynamic value based on a dynamic characteristic of each of the plurality of mobile terminals to be located within a monitoring range; determining a step size adjustment value based on the scene dynamic value; and determining the iteration step size η_{θ} based on the base step size and the step size adjustment value.

η_{θ} refers to an iteration step size for updating the angle parameter θ via gradient descent, and the value of η_{θ} determines a magnitude for updating θ along the gradient direction in each iteration. For example, the base step size may be 0.01. The base step size io may be reduced to 0.001 in a high-dynamic scenario and increased to 0.05 in a low-dynamic scenario.

In some embodiments, the processor determines the base step size no based on a preset value defined by an empirical rule, a prior simulation result, or the like.

In some embodiments, the processor determines the base step size based on the total count M of the plurality of mobile terminals to be located and the count of antennas in an antenna array of the 5G AeroMACS multi-antenna base station.

When the total count M of the mobile terminal to be located is larger, the dimensionality of the parameter space is higher, and the surface of the likelihood function is more complex. A smaller base step size is typically required to ensure convergence and stability of the gradient descent process, to avoid significant oscillations among the multi-target parameters.

In some embodiments, the processor determines the base step size based on an inverse relationship between the base step size and the total count of the mobile terminals to be located.

The count of antennas determines a dimensionality of the received signal vector and a dimensionality of the echo channel gain matrix. A larger count of antennas provides richer information but also increases computational complexity. The processor may adjust the base step size based on the count of antennas to balance computational speed and convergence accuracy.

In some embodiments, the processor determines the base step size based on an inverse relationship between the base step size and the count of antennas.

In some embodiments, during system operation or testing phases, a lookup table is generated. The table entries contain recommended η₀ values corresponding to different combinations of M and Nₐₙₜ. During runtime, the processor queries the lookup table to obtain the base step size.

In some embodiments, the iteration step size achieves a reasonable balance between parameter dimensionality and array resolvability, thereby ensuring algorithm stability when the count of targets is large or degrees of freedom are limited, and accelerating convergence when array resolution is high, or targets are sparse. This approach enhances the convergence speed and accuracy of angle estimation, reduces the risk of iteration failure or oscillation, and facilitates real-time online deployment and reliable operation of the system.

The dynamic characteristic refers to a physical quantity describing the motion state of the mobile terminal to be located, such as a radial velocity vᵣ, and a corresponding Doppler frequency shift f_{d} directly affects the phase and amplitude of the echo signal and serves as a key indicator for determining a dynamic degree of a scene. For example, when a target approaches the base station at a high speed, the radial velocity of the target is large, and the radial velocity has a more significant impact on beam tracking and positioning stability.

In some embodiments, the processor obtains the dynamic characteristic of each target within the monitoring range based on the echo signal in a mathematical manner. For example, the processor performs pulse sequence processing on the received echo signal over a coherent processing interval (CPI); for the echo signal associated with each target, a Fast Fourier Transform (FFT) is performed to obtain a spectral peak position corresponding to the Doppler shift f_{d,k} of the target k. The processor calculates the radial velocity of each target k according to the formula

$${v}_{r , k} = \frac{{f}_{d , k} c}{2 {f}_{c}} ,$$

where c is the speed of light, and f_{c} is a carrier frequency, and a set of dynamic characteristics {v_{r,1}, v_{r,2}, . . . , v_{r,M}} of all M targets within the monitoring range is obtained.

The scene dynamic value ρ_{scene} is an aggregated indicator for quantifying an overall “dynamic degree” of a current monitoring scene. A larger scene dynamic value indicates that a target with a higher moving speed exists in the scene, and the overall dynamic environment is more unstable. For example, when a plurality of targets approach the base station but the moving speed of one target is much higher than the moving speeds of other targets, the target dominates the scene dynamic value.

In some embodiments, the processor determines the scene dynamic value based on a Worst-Case Principle to ensure that the system maintains stable in highly dynamic environments. For example, the processor selects a maximum absolute value among the radial velocities of all targets as the scene dynamic value, and the expression is:

$${ρ}_{scene} = {max}_{k ∈ \{ 1 , … , M \}} \vert {v}_{r , k} \vert$$

This approach can ensure that adjustment to the system's step size or algorithm parameters are based on the most unfavorable target, thereby improving safety margins and algorithm robustness.

The step size adjustment value Δη is a correction amount applied to the base step size based on the scene dynamic value, and the step size adjustment value Δη may be implemented through monotonic function mapping.

When reducing the step size in high dynamic scenarios, a suppression-type mapping is used:

$${η}_{θ} = \frac{{η}_{0}}{1 + κ D} ,$$

where η_{θ} denotes the iteration step size for the angle parameter, η₀ denotes the base step size value, K denotes a suppression coefficient, and D denotes the scene dynamic value.

When slightly increasing the step size to track rapid changes in high dynamic scenarios, an enhancement-type mapping is used η_{θ}=η₀(1+αD), where α denotes a dynamic sensitivity factor.

In practice, the suppression-type mapping or a hybrid mapping is preferably used, combined with smoothing filtering (e.g., first-order low-pass filtering is performed to smooth D) to avoid abrupt changes in the step size. The hybrid mapping refers to a dynamic step size adjustment mechanism in gradient descent that combines the advantages of the suppression-type mapping and the enhancement-type mapping, integrating or alternately applying these two step size adjustment strategies to determine the actual iteration step size.

In some embodiments, the processor multiplies the base step size by the step size adjustment value to obtain the iteration step size η_{θ}.

The step size adjustment value Δη is a dimensionless multiplicative factor used to amplify the base step size or keep the base step size unchanged based on the dynamic degree of the scene.

In some embodiments, when the target (i.e., the mobile terminal to be located) moves at a high speed, the dynamic degree of the scene is large. At this time, the uncertainty in predicting the current position based on the previous position also increases. To quickly “catch up” and re-lock onto the target, a larger search step size is required in the initial phase of gradient descent to overcome this uncertainty. Therefore, the processor dynamically adjusts the iteration step size using the step size adjustment value Δη to adapt to the motion state of the target.

In some embodiments, the step size adjustment value Δη is calculated through the following formula:

$$Δ η = 1 + α \cdot \frac{{ρ}_{scene}}{{v}_{max}}$$

wherein α denotes an adjustable dynamic sensitivity factor for controlling the intensity of step size variation with speed;

$$\frac{{ρ}_{scene}}{{v}_{max}} ,$$

denotes the dynamic degree of the scene; vax denotes a maximum processable speed designed for the system (e.g., 500 km/h), which normalizes the proportional term

$$\frac{{ρ}_{scene}}{{v}_{max}} ,$$

so that Δη is a reasonable, bounded adjustment value.

By aggregating the dynamic characteristics of all targets within the monitoring range and determining the scene dynamic value, the system can reflect the dynamic changes of the overall motion environment in real time. Based on this, the system adaptively adjusts key algorithm parameters (such as the iteration step size, a beam tracking rate, etc.), thereby enhancing positioning stability and tracking accuracy in high-speed maneuvering scenarios. This effectively prevents performance degradation caused by individual highly dynamic targets and improves the robustness and safety of the integrated communication and positioning system.

The use of Capon beamforming to determine initial values enables precise differentiation of multi-target angles, avoiding local optima and ensuring the high precision and robustness of the final estimates. The optimization of parameters using Maximum Likelihood Estimation (MLE) provides statistical optimality, ensuring the reliability and accuracy of the estimates. By combining initial value determination with iterative optimization, the approach leverages both the angular resolution of the Capon technique and the computational efficiency of gradient descent. This balances computational complexity and estimation performance, allowing the system to respond quickly to moving targets on the airport surface.

Step S3: constructing a Fisher information matrix based on the estimates of the sensing-and-positioning parameters, and obtaining the CRB for the sensing-and-positioning parameters from the Fisher information matrix.

The Fisher information matrix is used to quantify the information content regarding target position parameters in echo data.

The Cramer-Rao Bound (CRB), i.e., the lower bound of the estimation error, is a lower bound for the variance of multi-target parameter estimation.

In some embodiments, the processor computes the Fisher information matrix corresponding to the complex channel gain coefficients and the angles of the targets based on the estimates of the sensing-and-positioning parameters, and obtains the CRB of the sensing-and-positioning parameters by inverting the Fisher information matrix.

After obtaining the complex channel gain coefficients and the angles of the targets, a CRB matrix corresponding to the complex channel gain coefficients and the angles of the targets is acquired by first computing the Fisher information matrix corresponding to the complex channel gain coefficients and the angles of the targets. According to the definition of the Fisher information matrix, an element in an i-th row and a j-th column of the matrix is calculated using the following formula:

$${F}_{ξ} [ i , j ] = \frac{2}{{σ}_{r}^{2}} Re ( \frac{\partial vec {( {A}_{r}^{*} {BA}_{t}^{H} X )}^{H}}{\partial ξ [ i ]} \cdot \frac{\partial vec ( {A}_{r}^{*} {BA}_{t}^{H} X )}{\partial ξ ⌈ j ]} ) \qquad ( 17 )$$

wherein F_{ξ}[i, j] denotes the value of the element in the i-th row and the j-th column of the Fisher information matrix for a parameter vector ξ to be estimated, i and j denote matrix indices, (⋅)^{H} denotes an operation of conjugate transpose, ξ[i] and ξ[j] denote the i-th row and the j-th column of the parameter vector ξ, respectively.

The corresponding CRB matrix for estimating

$$ξ is C = {F}_{ξ}^{- 1} , where {F}_{ξ}^{- 1}$$

denotes the inverse matrix of F_{ξ}. In one or more embodiments of the present disclosure, a trace of the CRB matrix is used as the CRB, expressed as:

$$CRB ( {R}_{x} ) = tr ( C ) = tr ( {F}_{i}^{- 1} ) \qquad ( 18 )$$

wherein CRB(⋅) denotes calculating the CRB, tr(⋅) denotes the trace of a matrix.

Through the above process, one or more embodiments of the present disclosure construct the Fisher information matrix for the parameters to be estimated from the echo signals obtained by the 5G AeroMACS multi-antenna base station and, by inverting the Fisher information matrix, ultimately obtain the CRB for the parameters to be estimated.

By adopting the CRB calculation process constructed from received samples, the array manifold, and known transmission sequences, the uncertainty in angle and complex gain estimation can be quantitatively characterized. This CRB can then be incorporated as an optimization objective or constraint into beam/covariance design. Consequently, under the premise of ensuring communication quality, the lower bound of positioning error is minimized in a targeted manner, significantly enhancing the positioning accuracy, resource utilization efficiency, and engineering feasibility of the integrated communication and navigation system.

Step S4: performing minimization optimization on the CRB based on channel characteristics of communication between the 5G AeroMACS multi-antenna base station and the plurality of single-antenna communication terminals, to obtain optimal beamforming parameters.

The channel characteristics of communication between the 5G AeroMACS multi-antenna base station and the plurality of single-antenna communication terminals are characterized by channel gain.

In some embodiments, under the constraints of guaranteeing a minimum communication rate requirement for the single-antenna communication terminals and a maximum transmission power limit, the optimal beamforming parameters are obtained by minimizing the CRB of the multi-target parameters. This achieves a trade-off between the CRB of multi-target sensing and positioning estimation error and the information multicast channel capacity.

In the preceding steps, the system for airport surface integrated communication and navigation according to one or more embodiments of the present disclosure utilizes echo signals obtained by the 5G AeroMACS multi-antenna base station to derive estimates of multi-target sensing-and-positioning parameters and subsequently obtains the corresponding lower bound of the estimation error, i.e., the CRB, thereby enabling simultaneous integration of communication and sensing functions and accomplishing beamforming.

In the present step, minimization optimization is performed on the CRB, and the following optimization problem is constructed:

$${min}_{w , {R}_{x} ≽ 0} CRB ( {R}_{sen} + {ww}^{H} ) \qquad ( 19 a )$$

$$s . t . {min}_{ke} \{ {log}_{2} ( 1 + \frac{{h}_{k}^{H} {ww}^{H} {h}_{k}}{{σ}_{c}^{2}} ) \} \geq {R}_{min} \qquad ( 19 b )$$

$$tr ( {R}_{sen} + {ww}^{H} ) \leq {P}_{max} \qquad ( 19 c )$$

$$wherein {min}_{w , {R}_{x} ≽ 0} ( \cdot )$$

denotes optimization to a minimum value under the condition that w, Rₓ [symbol] 0, s.t. denotes the subjected constraint conditions, Rₘᵢₙ denotes a minimum communication rate of the single-antenna communication terminals, and Pₘₐₓ denotes a maximum transmit power.

In some embodiments, in the step S4-1, the processor determines the minimum communication rate Rₘᵢₙ of the single-antenna communication terminals based on the dynamic context of the actual scene, including: identifying whether any mobile terminal to be located is in a high-precision approach scenario; in response to at least one of the plurality of mobile terminals to be located being in the high-precision approach scenario, setting the minimum communication rate Rₘᵢₙ of the single-antenna communication terminals to a first rate; and in response to none of the plurality of mobile terminals to be located being in the high-precision approach scenario, setting the minimum communication rate Rₘᵢₙ of the single-antenna communication terminals to a second rate. The first rate is lower than the second rate.

In some embodiments, the processor identifies whether any mobile terminal to be located is in a high-precision approach scenario.

The high-precision approach scenario refers to an operational condition on the airport surface in which a mobile terminal to be located (e.g., an apron vehicle or a taxiing aircraft/UAV) enters a spatial region and altitude interval requiring higher positioning accuracy and a higher update rate. For example, the high-precision approach scenario includes a low-altitude approach phase when the terminal is near a runway threshold or a fine maneuvering phase when the terminal is close to a parking stand.

In some embodiments, the processor identifies whether any mobile terminal to be located is at a position satisfying a preset position condition and has a height satisfying a preset altitude condition; in response to at least one of the plurality of mobile terminals to be located satisfying both the preset position condition and the preset altitude condition, determining that the at least one mobile terminal to be located is in the high-precision approach scenario.

The preset position condition refers to the mobile terminal to be located being within a specific trapezoidal area in front of the runway threshold, for example, within a range of tX degrees from the runway centerline extension and from Y kilometers to X kilometers from the runway threshold.

In some embodiments, the processor determines whether the preset position condition is satisfied by performing a spatial containment check between the latitude and longitude coordinates of the target and a predefined geofencing rule, or by calculating a horizontal distance and a lateral deviation with respect to a reference point. In response to a determination that the preset position condition is satisfied, the processor may further determine whether the altitude of the mobile terminal to be located satisfies the preset altitude condition.

In some embodiments, the processor obtains position information (e.g., latitude and longitude coordinates) of the mobile terminal to be located through inertial navigation/odometer reporting or vision/radar.

The preset altitude condition refers to the altitude of the mobile terminal to be located being lower than an altitude threshold (e.g., 100 m). The altitude threshold may be set according to runway type, aircraft type, or airport limitations.

In some embodiments, the processor obtains the altitude of the mobile terminal to be located by acquiring data reported by a height sensor (e.g., a barometric altimeter) of the mobile terminal to be located.

By simultaneously evaluating the spatial position and the altitude of the target, and identifying the high-precision approach scenario only when both conditions are satisfied, the system can promptly switch to finer-grained positioning and beam control strategies during critical approach phases. This significantly improves positioning accuracy and update frequency in low-altitude near-field regions, reduces positioning error and latency during approach, and enhances the safety and situational awareness for airport surface operations. Additionally, robustness in determination and a low false-trigger rate are ensured through confidence and hysteresis mechanisms.

After the processor identifies whether any mobile terminal to be located is in the high-precision approach scenario, two situations may arise: either at least one mobile terminal to be located is in the high-precision approach scenario, or no mobile terminals to be located are in the high-precision approach scenario.

In some embodiments, in response to at least one mobile terminal to be located among the plurality of mobile terminals to be located being in the high-precision approach scenario, the processor sets the minimum communication rate Rₘᵢₙ of the single-antenna communication terminals to a first rate. In response to none of the plurality of mobile terminals to be located being in the high-precision approach scenario, the processor sets the minimum communication rate Rₘᵢₙ of the single-antenna communication terminals to a second rate. The first rate is lower than the second rate.

The second rate corresponds to a general speed during routine cruising/taxiing. In some embodiments, the processor sets the second rate to a high-bandwidth mode (e.g., Rₘᵢₙ=20 Mbps), meeting requirements such as in-flight video transmission and passenger Wi-Fi.

The first rate corresponds to the speed during approach and landing. In some embodiments, the processor sets the first rate to a minimal control mode (e.g., Rₘᵢₙ=20 Mbps), meeting extremely low-bandwidth needs such as telemetry data and flight control commands.

The first rate and the second rate are preset based on historical experience.

By jointly evaluating position and altitude, and integrating multi-source data fusion with confidence-level verification to identify the high-precision approach scenario, the system can switch to a higher-precision positioning and beam control mode as required. When in the high-precision approach scenario (e.g., aircraft landing), energy is concentrated to ensure positioning accuracy for the landing aircraft. This significantly improves positioning accuracy, reduces positioning latency, and enhances system robustness against complex electromagnetic environments in the near field during critical approach and low-altitude phases, meeting the stringent requirements of airport operations for safety and precise situational awareness.

On this basis, to address the non-convexity of the function, by substituting Rₛₑₙ=Rₓ−ww^{H} and introducing

$$Γ = {σ}_{c}^{2} ( {2}^{{R}_{min}} - 1 ) ,$$

the optimization problem may be equivalently re-stated as follows:

$${min}_{w , {R}_{x}} CRB ( {R}_{x}^{- 1} ) \qquad ( 20 a )$$

$$s . t . {h}_{k}^{H} {ww}^{H} {h}_{k} \geq Γ \qquad ( 20 b )$$

$$tr ( {R}_{x} ) \leq {P}_{max} \qquad ( 20 c )$$

$${R}_{x} - {ww}^{H} ≽ 0 \qquad ( 20 d )$$

$$wherein {R}_{x}^{- 1}$$

denotes an inverse matrix of

$${R}_{x} , and {min}_{w , {R}_{x}} ( \cdot )$$

denotes optimization to a minimum value under the condition that w and Rₓ take any values.

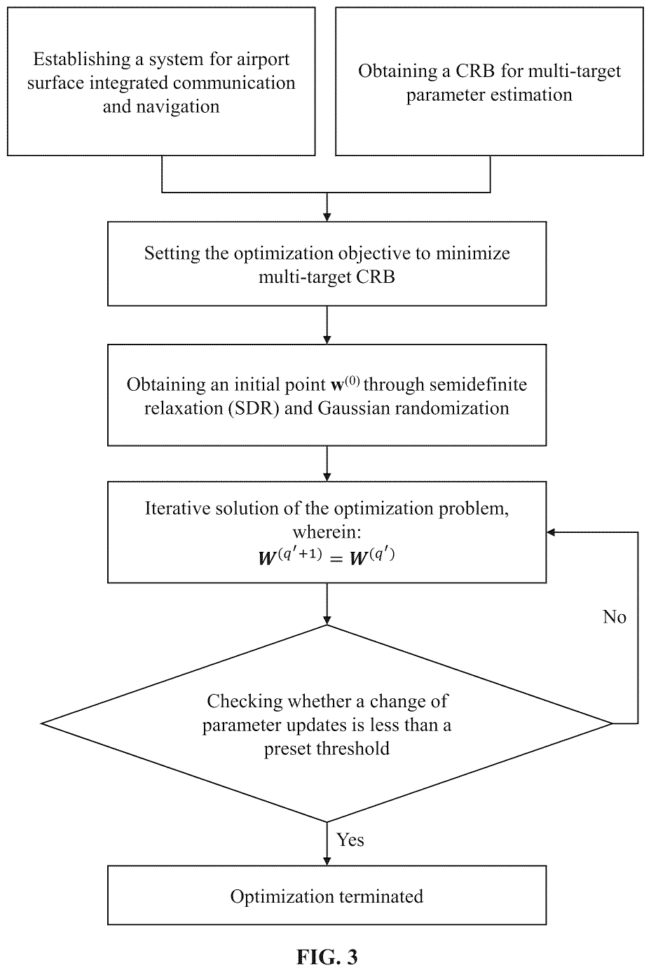

At this point, due to the presence of non-convex quadratic constraints in the optimization problem, the restated problem remains non-convex. For this problem, one or more embodiments of the present disclosure provide an algorithm based on Successive Convex Approximation (SCA), as shown in the flowchart illustrating the beamforming design algorithm based on SCA (also referred to as a SCA-based algorithm) in FIG. 3. The SCA-based algorithm iteratively finds a solution to the problem in an iterative manner by approximating the original problem as a series of convex problems. The specific steps are as follows:

Let the iteration count be q′. w^{(q′)} and Rₓ^{(q′)} denote local solution points for w and Rₓ in the optimization process, respectively, and are optimal solutions obtained in the q′-th iteration. Based on a first-order Taylor expansion, the following is derived:

$${h}_{k}^{H} {ww}^{H} {h}_{k} \geq 2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \qquad ( 21 )$$

Substituting this formula into the formulation of the optimization problem, the non-convex quadratic constraint in the original constraints may be approximated as:

$$2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \geq Γ , ∀ k ∈ \qquad ( 22 )$$

wherein ∀ denotes for any.

At this point, the formulation of the optimization problem is rewritten as:

$${min}_{w , {R}_{x}} CRB ( {R}_{x}^{- 1} ) \qquad ( 23 a )$$

$$s . t . {R}_{x} - {ww}^{H} 0 \qquad ( 23 b )$$

$$tr ( {R}_{x} ) \leq {P}_{max} \qquad ( 23 c )$$

$$2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \geq Γ , ∀ k ∈ \qquad ( 23 d )$$

At this point, the optimization problem is convex. For this convex optimization problem, numerical optimization tools such as CVX may be employed to find an optimal solution. In each iteration, the obtained optimal solution is used as an initial point for a next iteration.

In some embodiments, step S4 further includes: step S4-2: determining an initial point of a precoding vector that satisfies a maximum multicast rate, based on semidefinite relaxation (SDR) and Gaussian randomization; and stepS 4-3: performing iterative updating on the initial point of the precoding vector based on the constraint conditions, terminating the iteration when an iteration termination condition is satisfied, and taking the iteratively updated precoding vector as the optimal beamforming parameters.

The SDR refers to converting an optimization problem containing non-convex quadratic or vector outer product constraints into a convex semidefinite programming (SDP) approximation problem by introducing matrix variables and relaxing the rank constraint to a positive semidefinite constraint.

The Gaussian randomization refers sampling multiple vectors from a complex Gaussian distribution [symbol] [symbol] (0, W*) based on the semidefinite matrix solution W* obtained from SDR. These vectors serve as candidates, from which an approximate rank-1 vector solution is obtained through normalization/projection and feasibility correction.

The multicast rate refers to an achievable rate when simultaneously transmitting the same content to a group of terminals. Formally, the multicast rate may be expressed [symbol] log₂(1+SINRₖ(w)), where SINR is calculated based on current channel estimates, a transmit vector w, and a noise power.

Therefore, to implement the SCA-based algorithm, a feasible initial point needs to be found. In some embodiments, step S4-2 includes: using an SDR and Gaussian randomization algorithm to obtain a semidefinite matrix by applying SDR to the constraint conditions of the minimization optimization; performing eigenvalue decomposition on the semidefinite matrix; and selecting a transmit communication precoding vector w_{τ} for beamforming such that w_{τ}=Vz, where V denotes an eigenvector matrix obtained through the semidefinite relaxation technique, and z denotes a random vector, and elements of z are uniformly distributed on a unit circle in a complex plane. For w_{τ}, a vector that satisfies transmission communication beamforming to achieve a maximum multicast rate is sought, and the precoding vector that achieves the maximum multicast rate is designated as the initial point wᵢₙᵢₜ of the SCA-based algorithm.

By generating candidate precoding vectors using the eigenvalue decomposition structure from SDR, combined with randomization and multicast rate evaluation to select the optimal initial point, a high-quality initial solution can be effectively constructed for non-convex precoding optimization. This improves the convergence speed and final performance of iterative optimization, thereby enhancing multicast efficiency while meeting communication constraints. Furthermore, it provides a stable initial precoding that is closer to the global optimum for the subsequent integrated communication-positioning beamforming.

In an embodiment, starting from wᵢₙᵢₜ, the processor performs iterative updates using any one or a combination of the following techniques until convergence: Successive Convex Approximation (SCA), a WMMSE alternating technique, a Projected Gradient technique, or numerical solving via CVX. In each iteration, the processor computes the solution or gradient for the subproblem, performs feasibility projection, and evaluates the objective function and constraints.

In some embodiments, the iteration termination condition includes: a relative change II w^{(t+1)}−w^{(t)}∥/∥w^{(t)}∥≤∈, a change in the objective or constraints being below a threshold, or reaching a maximum iteration count Tₘₐₓ. When the iteration termination condition is satisfied, the processor outputs a final precoding wₒₚₜ, which is then loaded into the transmission link by the base station's transmission subsystem for beamforming implementation.

In some embodiments of the present disclosure, the processor obtains the coefficients involved in step 4 by invoking system-stored data, acquiring real-time measurement data, or through any other feasible means.

Using SDR combined with Gaussian randomization for initial point generation, followed by constraint-preserving iterative updates, effectively leverages the global information from convex relaxation and the feasibility recovery capability of randomization, significantly improving both convergence speed and final performance of precoding solutions. The approach efficiently enhances the multicast rate while satisfying transmit power and communication QoS constraints, and provides a stable transmission strategy that supports positioning performance optimization, thereby enhancing the overall efficiency, robustness, and engineering feasibility of the system for integrated communication and navigation system.

In some embodiments, step S4-3 specifically includes: performing the iterative optimization on the constraint conditions by using a numerical optimization tool CVX, with wᵢₙᵢₜ as an initial point, and performing a plurality of iterations, wherein

$${w}_{opt}^{( q ′ )}$$

denotes a solution for the precoding vector w of the optimization problem at a q′-th iteration; and ending the iterations in response to a change between

$${w}_{opt}^{( q ′ )} and {w}_{opt}^{( q ′ + 1 )}$$

being less than the preset threshold, and determining an obtained optimal precoding vector wₒₚₜ as the optimal beamforming parameters.

Let

$${w}_{opt}^{( q ′ )}$$

denote an optimal solution of the precoding vector w of the optimization problem in a q′-th iteration. Starting from wᵢₙᵢₜ as the initial point, multiple iterations are performed. The iteration is completed when a termination condition of the SCA-based algorithm is satisfied.

In some embodiments, the termination condition of the SCA-based algorithm may be one or more of the following: a change in the parameter estimates being less than a preset threshold, a norm of the gradient being less than a preset threshold, or a maximum count of iterations is reached.

By utilizing CVX to iteratively solve the problem under given constraints with a suitable initial point, a feasible precoding vector that satisfies both transmit power and communication QoS constraints can be obtained. The approach exhibits good convergence and is readily implementable in practice. This enables optimization of multicast- or positioning-related objectives-such as minimizing the CRB or maximizing the multicast rate—while guaranteeing the minimum communication rate for the single-antenna terminals, thereby significantly enhancing the integrated communication-positioning performance and deployment feasibility of the system.

Step S5: controlling, by using the optimal beamforming parameters, the 5G AeroMACS multi-antenna base station to perform signal transmission, to complete communication with the plurality of single-antenna communication terminals and positioning of the plurality of mobile terminals to be located.

The optimal solution wₒₚₜ is used as the optimal beamforming precoding vector to control the phase and amplitude of the signals to be transmitted by the antennas of the 5G AeroMACS multi-antenna base station, thereby enhancing the signal in designated directions and improving signal coverage and reception quality. Finally, efficient wireless communication and precise navigation guidance for the airport surface are achieved.

The optimal beamforming parameters are the solution of the minimization optimization problem in step S4. The optimal beamforming parameters balance multi-target sensing accuracy and minimum communication rate requirements of the single-antenna communication terminals.

The 5G AeroMACS multi-antenna base station employs the optimal beamforming parameters to control the phase and amplitude of the signals to be transmitted by the base station antennas, thereby enhancing the signal in designated directions and improving both signal coverage and reception quality.

In some embodiments, the processor controls the antenna array of the 5G AeroMACS multi-antenna base station to perform signal transmission externally with target phases and target amplitudes based on the optimal beamforming parameters. The target phases and the target amplitudes include phases and amplitudes indicated in the optimal beamforming parameters.

The target phase and the target amplitude refer to a phase value and an amplitude value (magnitude) applied to each transmit antenna element, as given by the optimal beamforming parameters (the precoding vector wₒₚₜ). For example, for an i-th antenna element, the target amplitude is |w_{opt,i}|, and the target phase is arg (w_{opt,i}).

In some embodiments, after completing step S4, the processor sends the computed optimal precoding vector wₒₚₜ to a transmission control unit. The transmission control unit calculates the target amplitude and the target phase for each antenna element based on wₒₚₜ, and saves the target amplitude |w_{opt,i}| and the target phase ∠w_{opt,i} as transmission configuration parameters for subsequent use.

By precisely mapping the optimal precoding vector to the target phase and the target amplitude for each antenna element and implementing this control in the transmit chain, the base station can form desired beam directions and shapes. This enhances energy concentration in the target direction and improves interference suppression capability, thereby ensuring communication QoS while increasing the accuracy of angle/gain estimation for positioning. Combined with normalization, quantization awareness, and closed-loop measurement correction, this approach ensures robust integrated communication-positioning transmission performance under hardware constraints.

In some embodiments, by using the optimal beamforming parameters to perform signal transmission, the processor broadcasts public information to all users at the airport while guaranteeing the minimum communication rate for the single-antenna communication terminals. Based on the echo signals, the processor acquires and optimizes the sensing and positioning accuracy for the mobile terminals to be located, thereby achieving efficient wireless communication and precise navigation guidance on the airport surface.

In some embodiments, the method for integrated communication and positioning in the 5G AeroMACS base station further includes step S6. Step S6 may be performed by the processor and includes: after performing signal transmission by using the optimal beamforming parameters, obtaining transmission performance indicators by measuring an actual transmitted signal, the transmission performance indicators including an actual total transmitted power and a peak-to-average ratio (PAPR); comparing the transmission performance indicators with constraint values set in step S4 to calculate a hardware distortion error; determining a signal compensation value from a digital predistortion lookup table based on the hardware distortion error in response to the hardware distortion error being greater than a preset error threshold; and controlling a power amplifier to operate based on the signal compensation value.

In some embodiments, after performing transmission by utilizing the optimal beamforming parameters, the processor obtains transmission performance indicators by measuring the actual transmitted signal.

The actual transmitted signal refers to a radio frequency (RF) signal that the 5G AeroMACS multi-antenna base station finally transmits into the air through the antenna array.

The transmission performance indicators refer to parameters for evaluating the quality, efficiency, and linearity of an output signal at a transmitting end of a wireless communication system. The transmission performance indicators include the actual total transmit power and the PAPR.

The actual total transmit power refers to instantaneous or average sum of the power radiated from all antenna elements, representing an analog RF signal that has been processed by the base station's physical RF front-end (including a Digital-to-Analog Converter (DAC), a mixer, and the Power amplifier (PA)) and is about to be or is being radiated from the antennas.

The actual total transmit power refers to instantaneous or average value of the sum of the power radiated from all antenna elements.

The peak-to-average ratio (PAPR) refers to a ratio of a peak instantaneous power to an average power of the signal. The PAPR is commonly expressed in decibels or as a linear ratio. An excessively high PAPR may cause the Power amplifier (PA) to operate in its nonlinear compression region.

In some embodiments, a directional coupler is installed at an output end of a main transmit path of the 5G AeroMACS multi-antenna base station, near the antennas. The directional coupler samples a portion of the energy from the transmitted signal, and the sampled signal is converted into digital signal samples by a feedback receiver. The feedback receiver includes an attenuator, a down-converter, a high-speed analog-to-digital converter, or the like.

In some embodiments, the processor receives the digital signal samples collected by the feedback receiver and analyzes the digital signal samples to obtain the transmission performance indicators of the actual transmitted signals, such as the actual total transmit power and the PAPR.

In some embodiments, the processor compares the transmission performance indicators with the constraint values set in step S4 to calculate the hardware distortion error.

The constraint values refer to values specified in the formulas in step S4. For example, the constraint values may include the maximum transmit power Pₘₐₓ.

The hardware distortion error may be one or more quantized scalar values that may be used for indexing.

The hardware distortion error may include a power error, a nonlinear distortion degree, or the like.

The power error refers to a difference between a calculated actual total transmit power and an expected power. The actual total transmit power is obtained via the directional coupler, the feedback receiver, or the like. The expected power is a power determined based on the optimal beamforming parameters and the transmit covariance matrix of the optimal beamforming parameters, which are finally determined in step S4.

The nonlinear distortion degree refers to the value of an Adjacent Channel Leakage Ratio (ACLR) calculated by measuring the power leakage of the signal into adjacent frequency bands. A worse ACLR indicates more severe nonlinear distortion.

An adjacent frequency band refers to a frequency channel immediately neighboring a given communication main band (i.e., the center frequency and bandwidth used by the base station for signal transmission). The power leakage refers to the phenomenon where a portion of the signal energy transmitted by the base station, which should be concentrated within its main band, spreads or “leaks” into adjacent frequency bands due to nonlinear distortion or other reasons. The processor measures the power leakage in real time through a feedback loop and determines an ACLR error.

The digital predistortion lookup table (LUT) is a multi-dimensional, pre-calibrated lookup table The multi-dimensional LUT includes a plurality of sub-lookup tables, e.g., a sub-lookup table 1 (corresponding to a distortion level 1), a sub-lookup table 2 (corresponding to a distortion level 2), or the like. The lookup table includes a plurality of records, e.g.:

$$[ Distortion State\_ 1 ] [ Signal Amplitude\_A ] -> Compensation Value\_X$$

$$[ Distortion State\_ 2 ] [ Signal Amplitude\_B ] -> Compensation Value\_Y .$$

In some embodiments, the processor utilizes a distortion state vector composed of power error and ACLR, and maps the vector to an index value according to a preset mapping rule. The index value indicates the current distortion level (e.g., distortion level 2). The mapping rule is based on an empirical formula or the lookup table obtained through offline calibration.

Based on the distortion level, the processor determines which sub-lookup table to retrieve and uses the sub-lookup table to determine the signal compensation value.

In some embodiments, the processor determines whether the hardware distortion error is greater than the preset error threshold. If the hardware distortion error is greater than the preset threshold, the processor determines the signal compensation value from the digital pre-distortion lookup table based on the hardware distortion error.

In some embodiments, the processor controls the power amplifier to operate based on the signal compensation value.

For example, the processor selects a sub-lookup table (Sub-LUT) from the multi-dimensional LUT based on the hardware distortion error. During real-time signal transmission, for each digital signal sample to be transmitted, the processor utilizes the magnitude of the digital signal sample as an address (i.e., a query address) to query the selected sub-lookup table and obtain a corresponding signal compensation value. The obtained signal compensation value is then sent to the DAC and radio frequency front-end to replace the original signal for driving the power amplifier (PA).

By performing real-time measurement of the actual transmitted signal and calculating the hardware distortion error based on the measurement result, the system determines and issues the signal compensation value utilizing the digital predistortion lookup table to control the power amplifier. This improves the fidelity and communication quality of the transmitted signal, thereby enhancing the stability, positioning accuracy, and equipment reliability of the integrated communication and navigation system.

One or more embodiments of the present disclosure achieve technical effects including, but not limited to, the following (1) to (4).
(1). The method provided by one or more embodiments of the present disclosure achieves a trade-off between the lower bound of multi-target sensing and positioning estimation error (CRB) and the information multicast channel capacity, ensuring the minimum rate requirement for information multicast while guaranteeing multi-target sensing accuracy. This trade-off mechanism enables the system to achieve optimal performance in both sensing/positioning and communication aspects of the airport base station.
(2) The method provided by one or more embodiments of the present disclosure, by minimizing the total CRB of multi-target parameters, enables the system to achieve optimal sensing accuracy across all targets, significantly reduces sensing errors, and improves the estimation accuracy of target parameters. This enhances the reliability and effectiveness of the system in complex airport surface scenarios that require precise positioning.
(3) For the non-convex quadratic constraint conditions involved in the optimization problem, one or more embodiments of the present disclosure adopt the SCA technique to transform the complex non-convex optimization problem into a more tractable convex form, simplifying the solution process while ensuring the convergence and stability of the optimization algorithm. Using SCA during the solving process enables rapid convergence to a highly reliable beamforming solution, guaranteeing operability in practical applications and improving computational efficiency. While ensuring the total communication rate for communication terminals, the method enhances the estimation accuracy of multi-target unknown parameters by minimizing the multi-target CRB.
(4) The CAML technique provided by one or more embodiments of the present disclosure, by combining MLE to optimize the estimation of target parameters, enables CAML to accurately distinguish target directions in multi-target environments, even when the angles between targets are very close. Meanwhile, maximum likelihood estimation possesses statistical optimality, providing minimum-variance unbiased estimation under a known noise model, ensuring the reliability and accuracy of the estimates given the measured echo data.

While specific embodiments of one or more embodiments of the present disclosure depict individual operations or steps using a particular order, this should be understood as requiring that such operations or steps be performed in the particular order shown or in a sequential order, or that all of the illustrated operations or steps should be performed in order to achieve a desired result. In certain environments, multitasking and parallel processing may be advantageous. Similarly, although several specific implementation details are included in the above discussion, the specific implementation details should not be construed as limitations on the scope of the present disclosure. Certain features described in the context of separate embodiments may also be implemented in combination in a single implementation. Conversely, various features described in the context of a single implementation may also be implemented separately or in any suitable sub-combination in the plurality of implementations. The above descriptions are merely specific implementations of one or more embodiments of the present disclosure. The protection scope of one or more embodiments of the present disclosure is not limited thereto. Any person skilled in the art can easily conceive of changes or substitutions within the technical scope disclosed in one or more embodiments of the present disclosure. All such changes or substitutions shall fall within the protection scope of one or more embodiments of the present disclosure.

The above descriptions are merely specific implementations of one or more embodiments of the present disclosure. The protection scope of one or more embodiments of the present disclosure is not limited thereto. Any person skilled in the art can easily conceive of changes or substitutions within the technical scope disclosed in one or more embodiments of the present disclosure. All such changes or substitutions shall fall within the protection scope of one or more embodiments of the present disclosure.

What is claimed is:

1. A method for integrated communication and positioning in a 5G AeroMACS multi-antenna base station, comprising:
step S1: establishing a system for airport surface integrated communication and navigation, the system including the 5G AeroMACS multi-antenna base station, a plurality of single-antenna communication terminals, and a plurality of mobile terminals to be located, wherein the 5G AeroMACS multi-antenna base station performs real-time communication with the plurality of single-antenna communication terminals and the plurality of mobile terminals to be located, respectively;
step S2: receiving, by the 5G AeroMACS multi-antenna base station, an echo signal transmitted by each of the plurality of mobile terminals to be located, and obtaining estimates of sensing-and-positioning parameters of each of the plurality of mobile terminals to be located based on the echo signal, wherein the sensing-and-positioning parameters include a complex channel gain coefficient β and an angle θ;
step S3: constructing a Fisher information matrix based on the estimates of the sensing-and-positioning parameters, and obtaining a Cramér-Rao Bound (CRB) for the sensing-and-positioning parameters from the Fisher information matrix;
step S4: performing minimization optimization on the CRB based on channel characteristics of a communication channel between the 5G AeroMACS multi-antenna base station and the plurality of single-antenna communication terminals, to obtain optimal beamforming parameters, including:
step S4-1: determining constraint conditions for performing the minimization optimization on the CRB, including:
determining an expression of the constraint conditions for performing the minimization optimization on the CRB:
$${min}_{w , {R}_{x}} CRB ( {R}_{x}^{- 1} )$$
$$s . t . {R}_{x} - {ww}^{H} 0$$
$$tr ( {R}_{x} ) \leq {P}_{max}$$
$$2 Re ( {w}^{H} {h}_{k} {h}_{k}^{H} {w}^{( q ′ )} ) - {w}^{( q ′ ) H} {h}_{k} {h}_{k}^{H} {w}^{( q ′ )} \geq Γ , ∀ k ∈$$
wherein, Rₓ denotes a transmit covariance matrix, Re{⋅} denotes a real part operator, CRB(⋅) denotes calculating the CRB,
$${min}_{w , {R}_{x}} ( \cdot )$$
denotes optimization to a minimum value under a condition that w and Rₓ take any values, Rₓ⁻¹ denotes an inverse matrix of Rₓ, s.t. denotes the constraint conditions, w denotes a precoding vector of the 5G AeroMACS multi-antenna base station, w^{H} denotes a conjugate transpose of w, Pₘₐₓ denotes a maximum transmit power, hₖ denotes a channel gain of a k-th single-antenna communication terminal,
$${h}_{k}^{H}$$
denotes a conjugate transpose of hₖ, k denotes an index of the single-antenna communication terminal, k∈ [symbol] , [symbol] ={1, 2, . . . K}, K denotes a count of the plurality of single-antenna communication terminals, w^{(q′)} denotes a precoding vector of a q′-th iteration, w^{(q′)H} denotes a conjugate transpose of
$${w}^{( q ′ )} , Γ = {σ}_{c}^{2} ( {2}^{{R}_{min}} - 1 ) , {σ}_{c}^{2}$$
denotes a noise variance at the single-antenna communication terminal, Rₘᵢₙ denotes a minimum communication rate of the single-antenna communication terminal, ∀ denotes for any; and
step S5: controlling, by using the optimal beamforming parameters, the 5G AeroMACS multi-antenna base station to perform signal transmission, to complete communication with the plurality of single-antenna communication terminals and positioning of the plurality of mobile terminals to be located.

2. The method of claim 1, wherein the step S2 includes:
step S2-1: receiving, by the 5G AeroMACS multi-antenna base station from an echo channel, the echo signal transmitted by each of the plurality of mobile terminals to be located;
step S2-2: determining initial values of the sensing-and-positioning parameters based on a Capon beamforming power spectrum, and determining a likelihood function based on the initial values of the sensing-and-positioning parameters; and
step S2-3: performing maximization optimization on the likelihood function through gradient descent to obtain optimal sensing-and-positioning parameters, and designating the optimal sensing-and-positioning parameters as the estimates of the sensing-and-positioning parameters.

3. The method of claim 2, wherein in step S2-1, the echo signal is expressed through a formula:
$$y ( n ) = {\sum }_{m = 1}^{M} G ( m ) x ( n ) + z ( n )$$
wherein, y(n) denotes an n-th signal received by the 5G AeroMACS multi-antenna base station, x(n) denotes an n-th signal transmitted by the 5G AeroMACS multi-antenna base station, n denotes a symbol index, n∈{1, 2, . . . L}, L denotes a total count of symbols in a communication symbol period, G(m) denotes an echo channel gain between the 5G AeroMACS multi-antenna base station and an m-th mobile terminal to be located, m denotes an index of the mobile terminal to be located, m∈{1, 2, . . . M}, M denotes a total count of the plurality of mobile terminals to be located, z(n) denotes additive white Gaussian noise of an n-th signal.

4. The method of claim 3, wherein the step S2-2 includes:
for each candidate target angle, calculating a Capon power spectrum, designating an angle corresponding to a peak value of the Capon power spectrum as an initial angle θᵢₙᵢₜ, and simultaneously selecting an initial complex channel gain coefficient βᵢₙᵢₜ; and
based on the θᵢₙᵢₜ and the βᵢₙᵢₜ, calculating the likelihood function according to a formula:
$$ℒ ( β , θ ) = {\prod }_{n = 1}^{L} \frac{1}{{π}^{M} {σ}_{r}^{2}} exp ( - \frac{{‖ y ( n ) - {\sum }_{m = 1}^{M} {β}_{m} {a}_{r} ( {θ}_{m} ) {a}_{t}^{H} ( {θ}_{m} ) x ( n ) ‖}^{2}}{{σ}_{r}^{2}} )$$
wherein, [symbol] (β, θ) denotes the likelihood function of observing the received signal y(n) given β, θ, βₘ denotes a complex channel gain coefficient of the m-th mobile terminal to be located, aₜ(θₘ) and aᵣ(θₘ) denote a transmit steering vector and a receive steering vector, respectively, at antennas of the 5G AeroMACS multi-antenna base station,
$${a}_{t}^{H} ( {θ}_{m} )$$
denotes a conjugate transpose of aₜ(θₘ), θₘ denotes an angle of the m-th mobile terminal to be located, exp(⋅) denotes an exponential function with base e, ∥⋅∥² denotes a squared L2 norm,
$${σ}_{r}^{2}$$
denotes a noise power at a receiving antenna.

5. The method of claim 4, wherein the step S2-3 includes:
performing gradient descent by using following formulas to iteratively update the sensing-and-positioning parameters:
$${β}_{m}^{( q + 1 )} = {β}_{m}^{( q )} + {η}_{β} {∇}_{{β}_{m}}$$
$${θ}_{m}^{( q + 1 )} = {θ}_{m}^{( q )} + {η}_{θ} {∇}_{{θ}_{m}}$$
$${∇}_{{β}_{m}} = {{\sum }_{n = 1}}^{L} 2 \cdot Re \{ {a}_{r}^{H} ( {θ}_{m}^{( q )} ) {a}_{t} ( {θ}_{m}^{( q )} ) x ( n ) {( y ( n ) - {{\sum }_{p = 1}}^{M} {β}_{p}^{( a )} {a}_{r} ( {θ}_{p}^{( q )} ) {a}_{t}^{H} ( {θ}_{p}^{( q )} ) x ( n ) )}^{H} \}$$
$${∇}_{{θ}_{m}} = {{\sum }_{n = 1}}^{L} 2 \cdot Re \{ {β}_{m}^{( q )} \frac{\partial }{\partial {θ}_{m}} ( {a}_{r} ( {θ}_{m}^{( q )} ) {a}_{t}^{H} ( {θ}_{m}^{( q )} ) x ( n ) ) {( y ( n ) - {{\sum }_{p = 1}}^{M} {β}_{p}^{( a )} {a}_{r} ( {θ}_{p}^{( q )} ) {a}_{t}^{H} ( {θ}_{p}^{( q )} ) x ( n ) )}^{H} \}$$
$$wherein , {θ}_{m}^{( q )} and {θ}_{p}^{( q )}$$
denote values of θₘ and θₚ at a q-th iteration, respectively, θₚ denotes an angle of a p-th mobile terminal to be located,
$${β}_{m}^{( q )} and {β}_{p}^{( q )}$$
denote values of βₘ and βₚ of at the q-th iteration, respectively, βₚ denotes a complex channel gain coefficient of the p-th mobile terminal to be located,
$${β}_{m}^{( q + 1 )} and {θ}_{m}^{( q + 1 )}$$
denote values of βₘ and θₘ of a (q+1)-th iteration, respectively, η_{β} and η_{θ} denote an iteration step size for β and an iteration step size for θ, respectively, Re{⋅} denotes the real part operator, and
$$\frac{\partial }{\partial {θ}_{m}}$$
denotes taking a partial derivative with respect to θₘ; and
during the iteration, if a change in the sensing-and-positioning parameters is less than a preset threshold, outputting the estimates of the sensing-and-positioning parameters, denoted as (\hat{β}ₘ, \hat{θ}ₘ).

6. The method of claim 5, wherein in the step S2-3, determining the iteration step size η_{θ} includes:
determining a base step size;
determining a scene dynamic value based on a dynamic characteristic of each of the plurality of mobile terminals to be located within a monitoring range;
determining a step size adjustment value based on the scene dynamic value; and
determining the iteration step size η_{θ} based on the base step size and the step size adjustment value.

7. The method of claim 6, wherein determining the base step size includes:
determining the base step size based on the total count M of the plurality of mobile terminals to be located and a count of the antennas in an antenna array of the 5G AeroMACS multi-antenna base station.

8. The method of claim 5, wherein the step S3 includes:
calculating the Fisher information matrix corresponding to complex channel gain coefficients and angles of targets based on the estimates of the sensing-and-positioning parameters, using a formula:
$${F}_{ξ} [ i , j ] = \frac{2}{{σ}_{r}^{2}} Re ( \frac{\partial {vec ( {A}_{r}^{*} {BA}_{t}^{H} X )}^{H}}{\partial ξ [ i ]} \cdot \frac{\partial vec ( {A}_{r}^{*} {BA}_{t}^{H} X )}{\partial ξ [ j ]} )$$
wherein, Aₜ and Aᵣ denote a transmit steering matrix and a receive steering matrix of the antennas, respectively,
$${A}_{r}^{*}$$
denotes a complex conjugate matrix of Aᵣ,
$${A}_{t}^{H}$$
denotes a conjugate transpose of Aₜ, X denotes a transmit signal matrix, B denotes a complex channel gain coefficient matrix, ξ denotes an estimated parameter matrix constituted by \hat{β}ₘ and \hat{θ}ₘ, F_{ξ}[i, j] denotes a value of an element at an i-th row and a j-th column of the Fisher information matrix of ξ, i, j denote matrix indices, (⋅)^{H} denotes an operation of conjugate transpose, ξ[i] and ξ[j] denote an i-th row and a j-th column of ξ, respectively, vec(⋅) denotes vectorizing a matrix; and
forming F_{ξ} with values of elements at the i-th row and the j-th column of the Fisher information matrix, wherein an expression of the CRB of the sensing-and-positioning parameters is:
$$CRB ( {R}_{x} ) = tr ( {F}_{ξ}^{- 1} )$$
wherein, Rₓ denotes the transmit covariance matrix, CRB(⋅) denotes calculating the CRB, tr(⋅) denotes a trace of a matrix,
$${F}_{ξ}^{- 1}$$
denotes an inverse matrix of the Fisher information matrix.

9. The method of claim 8, wherein the step S4 further includes:
step S4-2: determining an initial point of a precoding vector that satisfies a maximum multicast rate, based on semidefinite relaxation (SDR) and Gaussian randomization; and
step S4-3: performing iterative updating on the initial point of the precoding vector based on the constraint conditions, terminating the iteration when an iteration termination condition is satisfied, and taking the iteratively updated precoding vector as the optimal beamforming parameters.

10. The method of claim 9, wherein the step S4-2 includes:
obtaining a semidefinite matrix by processing the constraint conditions for the minimization optimization through the SDR, and performing eigenvalue decomposition on the semidefinite matrix;
selecting w_{τ} such that w_{τ}=Vz is satisfied, wherein V denotes an eigenvector matrix obtained through the SDR, and z denotes a random vector with elements uniformly distributed on a unit circle in a complex plane; and
for w_{τ}, finding a vector from w_{τ} that satisfies transmit communication beamforming to achieve the maximum multicast rate, and designating a precoding vector achieving the maximum multicast rate as the initial point wᵢₙᵢₜ.

11. The method of claim 10, wherein the step S4-3 includes:
performing iterative optimization on the constraint conditions by using a numerical optimization tool CVX, with wᵢₙᵢₜ as the initial point, and performing a plurality of iterations, wherein
$${w}_{opt}^{( {q}^{′} )}$$
represents a solution for a precoding vector w of an optimization problem at a q′-th iteration; and
ending the iterations in response to a change between
$${w}_{opt}^{( {q}^{′} )} and {w}_{opt}^{( {q}^{′} + 1 )}$$
being less than a preset threshold, and determining an obtained optimal precoding vector wₒₚₜ as the optimal beamforming parameters.

12. The method of claim 1, wherein in the step S4-1, the minimum communication rate Rₘᵢₙ of the single-antenna communication terminal is dynamically determined according to an actual scenario includes:
identifying whether any mobile terminal to be located is in a high-precision approach scenario;
in response to at least one mobile terminal to be located among the plurality of mobile terminals to be located being in the high-precision approach scenario, setting the minimum communication rate Rₘᵢₙ of the single-antenna communication terminals to a first rate; and
in response to none of the plurality of mobile terminals to be located being in the high-precision approach scenario, setting the minimum communication rate Rₘᵢₙ of the single-antenna communication terminals to a second rate;
wherein the first rate is lower than the second rate.

13. The method of claim 12, wherein the identifying whether any mobile terminal to be located is in a high-precision approach scenario includes:
identifying whether any mobile terminal to be located is at a position satisfying a preset position condition and has a height satisfying a preset altitude condition;
in response to at least one mobile terminal to be located among the plurality of mobile terminals to be located satisfying both the preset position condition and the preset altitude condition, determining that the at least one mobile terminal to be located is in the high-precision approach scenario.

14. The method of claim 1, wherein the step S5 includes:
controlling an antenna array of the 5G AeroMACS multi-antenna base station to perform signal transmission externally with target phases and target amplitudes based on the optimal beamforming parameters, wherein the target phases and the target amplitudes include phases and amplitudes indicated in the optimal beamforming parameters.

15. The method of claim 1, further comprising a step S6, including:
after performing the signal transmission by using the optimal beamforming parameters, obtaining transmission performance indicators by measuring an actual transmitted signal, the transmission performance indicators including an actual total transmitted power and a peak-to-average ratio (PAPR);
comparing the transmission performance indicators with constraint values set in the step S4 to calculate a hardware distortion error;
determining a signal compensation value from a digital predistortion lookup table based on the hardware distortion error in response to the hardware distortion error being greater than a preset error threshold; and
controlling a power amplifier to operate based on the signal compensation value.
